(19) United States
(12) Patent Application Publication
(10) Pub. No.: US 2018/0219773 A1
(43) Pub. Date: Aug. 2, 2018

(54) INTERCONNECTION OF OVERLAY NETWORKS

(71) Applicant: Nokia Technologies Oy, Espoo (FI)

(72) Inventor: Desheng LI, Chuzhou (CN)

(21) Appl. No.: 15/746,249

(22) PCT Filed: Aug. 4, 2015
(86) PCT No.: PCT/CN2015/085994

§ 371 Date: Jan. 19, 2018

(51) Int. Cl. H04L 12/715; H04L 29/12; H04L 12/46; G06F 9/455

(52) U.S. Cl. CPC H04L 45/64; H04L 61/103; G06F 2009/45595; H04L 12/4633; G06F 9/45558; H04L 12/4641

(57) ABSTRACT

Embodiments of the invention generally relate to interconnection of overlay networks. The communication device is provided. The device comprises a first VTEP coupled to a first overlay network and a second VTEP coupled to a second overlay network, wherein the first and second overlay networks use a same virtual network identifier. The first VTEP is configured to receive, from the first overlay network, an address resolution request for a destination VM in the second overlay network, wherein the address resolution request contains an IP address of the destination VM. The second VTEP is configured to forward the address resolution request to the second overlay network, receive the address resolution response from the second overlay network and obtain the endpoint information associated with the destination VM from the address resolution response. The first VTEP is further configured to send the endpoint information to the first overlay network. In this way, the endpoint information associated with VMs in different overlay networks using the same virtual network identifier may be forwarded between the overlay networks.

### TECHNICAL FIELD

Embodiments of the present invention generally relate to the field of communications, and more particularly to a method and apparatus for interconnection of overlay networks.

### BACKGROUND

Development of network virtualization brings great demands for a high network capacity and efficiency. An overlay network technique, which is known as a popular network virtualization technique, may accommodate hundreds of thousands of virtual machines (VMs) and thereby may greatly improve the network capacity and efficiency. Generally, an overlay network based on the overlay network technique is built on top of underlying physical network infrastructures. The underlying physical network infrastructures may comprise a plurality of computing devices. Example computing devices include, but are not limited to, a server, a switch, a desktop computer, a laptop computer, a tablet, a smartphone, a mobile phone, a Personal Digital Assistant (PDA) and the like. Virtual nodes in the overlay network may be connected by virtual or logical links, and each link corresponds to one or more physical links between the computing devices in the underlying physical network.

Virtual eXtensible Local Area Network (VXLAN) is a typical overlay network technique for overlaying virtualized layer 2 networks over layer 3 networks. VXLAN enables tunneling transmission of a Media Access Control (MAC) packet into an Internet Protocol (IP) packet. Specifically, there may be a plurality of VMs and VXLAN Tunnel End Points (VTEPs) in a VXLAN network. One VTEP is connected to one or more VMs. The VTEP or VM may be located within one or more computing devices in the underlying physical network. If a source VM intends to send data to a destination VM, the source VM generates a data packet and transmits the packet to a source VTEP connected thereto. Upon reception of the data packet, the source VTEP encapsulates the packet into an overlay packet by inserting an outer header and transmits the overlay packet to a destination VTEP which is connected to the destination VM. As used herein, the term “overlay packet” refers to an encapsulated packet transmitted between two VTEPs, which is generated by one of the VTEPs by using an outer header to encapsulate a packet from a corresponding VM. After the destination VTEP receives the overlay packet, the destination VTEP decapsulates the overlay packet into the data packet and transmits the data packet to the destination VM. Thus, the source and destination VTEPs form a tunnel for the transmission of a data packet.

A general VXLAN network and a Software Defined Network (SDN) VXLAN network are two typical VXLAN networks. The Internet Engineering Task Force (IETF) has proposed Request for Comments (RFC) 7348 for specifying a framework of the general VXLAN network. As for the SDN VXLAN network, a specific vendor is allowed to specify a specific framework.

### SUMMARY

Generally, embodiments of the present invention provide an efficient solution for the interconnection of overlay networks.

In a first aspect, a communication device is provided. The device comprises a first VTEP coupled to a first overlay network and a second VTEP coupled to a second overlay network, wherein the first and second overlay networks use a same virtual network identifier. The first VTEP is configured to receive, from the first overlay network, an address resolution request for a destination virtual machine (VM) in the second overlay network, wherein the address resolution request contains an Internet Protocol (IP) address of the destination VM. The second VTEP is configured to forward the address resolution request to the second overlay network, receive the address resolution response from the second overlay network and obtain endpoint information associated with the destination VM from the address resolution response. The first VTEP is further configured to send the endpoint information to the first overlay network.

In a second aspect, a communication method is provided. The method comprising: receiving, from a first overlay network, an address resolution request for a destination virtual machine (VM) in a second overlay network, the first and second overlay networks using a same virtual network identifier, and the address resolution request containing an Internet Protocol (IP) address of the destination VM; forwarding the address resolution request to the second overlay network; receiving, from the second overlay network, the address resolution response for the address resolution request; obtaining the endpoint information associated with the destination VM from the address resolution response; and sending the endpoint information to the first overlay network. The corresponding computer program product is also provided.

According to embodiments of the present invention, with the mediator, the endpoint information associated with VMs in different overlay networks using the same virtual network identifier may be forwarded between the overlay networks. In this way, a source VM in one overlay network may directly communicate with a destination VM in another overlay network. Such a direct communication may effectively and efficiently avoid a problem of the performance bottle and the single point of failure.

### BRIEF DESCRIPTION OF THE DRAWINGS

FIG. 1 illustrates an environment in which embodiments of the present invention may be implemented;

FIG. 2 illustrates an example structure of the mediator according to one embodiment of the present invention;

FIG. 3 illustrates an example structure of the mediator according to another embodiment of the present invention;

FIG. 4 illustrates an example scenario where the mediator enables the communication between the VM in the SDN VXLAN network and the non-SDN VXLAN network in accordance with one embodiment of the present invention;

FIG. 5 illustrates a process of forwarding a broadcast packet by the mediator from the SDN VXLAN network to the non-SDN VXLAN network in accordance with one embodiment of the present invention; and

FIG. 6 illustrates a flowchart of a communication method in accordance with one embodiment of the present invention.

### DETAILED DESCRIPTION

The present invention will now be discussed with reference to several example embodiments. It should be understood that these embodiments are discussed only for the purpose of enabling those skilled persons in the art to better understand and thus implement the present invention, rather than suggesting any limitations on the scope of the present invention.

As used herein, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

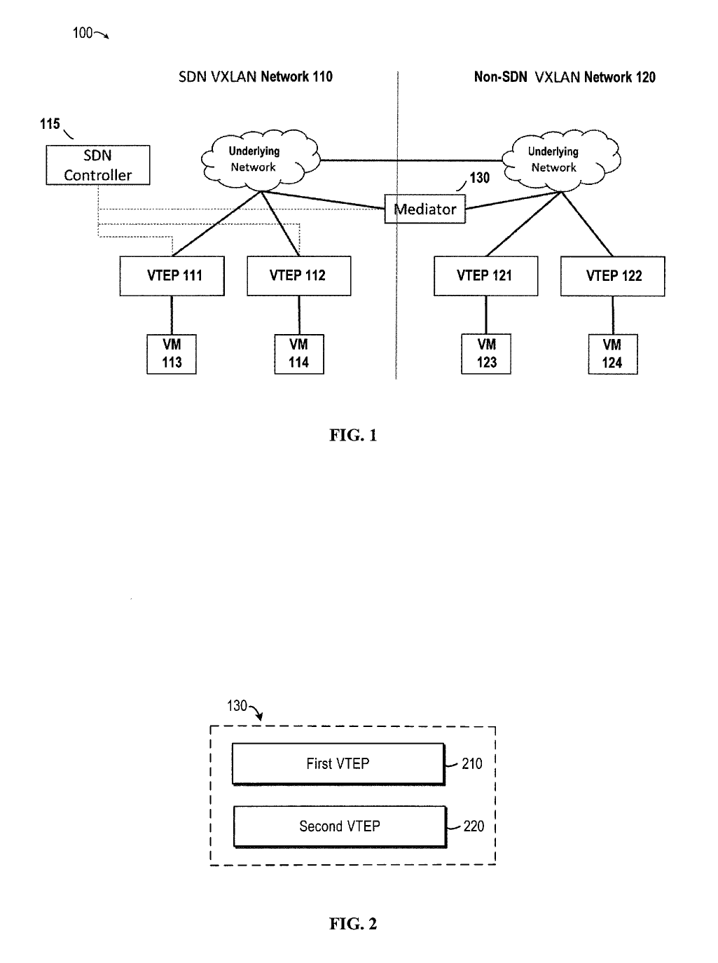

FIG. 1 shows an example environment 100 in which embodiments of the present invention may be implemented. As shown, in the environment 100, there are two overlay networks including a SDN VXLAN network 110 and a non-SDN VXLAN network 120. In the context of the present invention, the term “non-SDN VXLAN network” refers to a VXLAN network the framework of which conforms to a standard, for example RFC 7348 as standardized by IETF.

As shown in FIG. 1, the SDN VXLAN network 110 comprises two VMs 113 and 114 and two SDN VTEPs 111 and 112 respectively connected to the VMs 113 and 114. The non-SDN VXLAN network 120 comprises two VMs 123 and 124 and two non-SDN VTEPs 121 and 122 respectively connected to the VMs 123 and 124. It would be appreciated that the number and types of overlay networks in the environment 100 is only for the purpose of illustration without suggesting the limitations. There may be any suitable number of overlay networks in the environment 100, and the overlay networks may be of any suitable type. Likewise, the numbers of the VMs and the VTEPs in an individual overlay network 110 or 120 are only for the purpose of illustration without suggesting the limitations. In the SDN VXLAN network 110 or the non-SDN VXLAN network 120, there may be any suitable number of VMs connected to any suitable number of VTEPs.

As described above, the overlay networks, such as the SDN VXLAN network 110 and the non-SDN VXLAN network 120, may be built on top of the underlying physical network which comprises a plurality of computing devices. Examples of the computing devices include, but are not limited to, a server, a switch, a desktop computer, a laptop computer, a tablet, a smartphone, a mobile phone, a PDA and the like. The virtual nodes in the overlay network, such as the VMs 113, 114, 123 and 124 and the VTEPs 111, 112, 121 and 122, may be located within one or more computing devices in the underlying physical network.

In the underlying physical network, a computing device may communicate over a communication medium to another computing device. Communication media include, but are not limited to, wired or wireless techniques implemented with an electrical, optical, RF, infrared, acoustic, or other carrier.

As described above, in a VXLAN network, a VTEP generally performs encapsulation and de-capsulation of packets. Logically, the VTEP may comprise an overlay module and a switching module. The switching module is connected to a VM via a local port and may receive a packet (sometimes also referred to as frame and the like) from the VM. As used herein, the term “local port” refers to any suitable virtual or logical port that enables transmission between a VM and a VTEP. The overlay module encapsulates the packet received from the VM into an overlay packet and sends the overlay packet to a remote VTEP over a virtual tunnel on top of the underlying physical network. In the meanwhile, the overlay module may decapsulate the overlay packet received via an external port from the remote VTEP, and then the decapsulated packet is sent to the VM in turn through the switch module and the local port. As used herein, the term “external port” refers to any suitable port that enables transmission between VTEPs.

The VXLAN network may comprise a plurality of VXLAN segments, and only the VMs within the same VXLAN segment may communication with each other. A VXLAN segment may be identified by a VXLAN network identifier (VNID) which is typically composed of 24 bits to enable up to 16 million VXLAN segments to coexist in the VXLAN network. In order to enable the communication between the VMs with the same VXLAN segment, the VTEP has a forwarding table containing entries for individual VNIDs. One entry of the forwarding table indicates mapping of a MAC address to a local port or to an IP address of a remote VTEP within the corresponding VXLAN segment.

Specifically, according to this example embodiment, when the VTEP receives the packet from the VM at the local port, the VTEP uses the destination MAC address of a destination VM to search the forwarding table for a local port towards the destination VM or the mapping IP address of a destination VTEP connected to the destination VM. In the context of the present invention, a source VM refers to a VM that initiates communication, and a destination VM refers to a VM that terminates communication. Accordingly, a source VTEP refers to a VTEP that is connected to the source VM via a local port, and a destination VTEP refers to a VTEP that is connected to the destination VM via a local port. After the mapped entry is found, the VTEP may determine whether the received packet should be delivered to the connected VM through a local port or be encapsulated and sent to the remote VTEP through a virtualization tunnel. On the other hand, when the encapsulated packet is received via the external interface, the VTEP uses the inner destination MAC address to search the forwarding table for a local port towards the destination VM. Then, the packet is decapsulated and delivered to the destination VM via the local port.

In accordance with agreements, in the SDN VXLAN network 110 and the non-SDN VXLAN network 120, the mapping of a MAC address to an IP addresses is created and updated by the VTEP in different ways. Specifically, the VTEP in the SDN VXLAN network 110 learns the addresses associated with VMs and VTEPs in a control plane, while the VTEP in the non-SDN VXLAN 120 learns the addresses associated with VMs and VTEPs in a data plane.

By way of example, in the case that the VM 123 initiates communication to the VM 124 in the non-SDN VXLAN network 120, after the source VTEP 121 receives from the source VM 123 a packet destined to the destination VM 124, the source VTEP 121 determines, by looking up the forwarding table, whether the source VM 123 and the destination VM 124 are within the same VXLAN segment and whether there is a mapping of the destination MAC address contained in the packet to an IP address of a remote VTEP 122 or a local port. In response to the mapping pointing to the VTEP 122, the source VTEP 121 encapsulates the packet using an outer header. The outer header may comprise a MAC header, an IP header and a VXLAN header, wherein the MAC header includes the MAC address of the destination VTEP 122, the IP header includes the IP address of the destination VTEP 122, and the VXLAN header includes the VNID. Then, the encapsulated packet is sent towards the VTEP 122.

Upon reception of the encapsulated packet, the destination VTEP 122 verifies validity of the VNID and determines, by looking up its own forwarding table, whether or not there is a VM among the connected VMs which corresponds to the VNID and uses the destination MAC address carried in the received packet. In response to the VM 124 being found, the received packet is decapsulated and delivered to the VM 124 via the corresponding local port.

In addition to delivering the packet to the destination VM 124, the destination VTEP 122 learns the mapping of the source MAC address of the VM 123 to the source IP address of the VTEP 121 and then stores this mapping in the forwarding table. In this way, when the destination VM 124 sends a response packet, the VTEP 122 may obtain the forwarding address information from the forwarding table, and therefore an unknown destination flooding of the response packet may be avoided.

In the SDN VXLAN network 110, the forwarding process is similar to that in the non-SDN VXLAN network 120. The VTEP 111 or 112 in the SDN VXLAN network 110 also uses the forwarding table to determine how to forward the packet received via the external interface or via the local port. The difference is that in the SDN VXLAN network 110, as described above, the addresses are learned in a control plane. Specifically, instead of learning the mapping between the addresses and creating the forwarding entry by itself in the data plane, the VTEP 111 or 112 queries a dedicated controller about endpoint information associated with the destination VM. In the context of the present invention, the endpoint information associated with a VM includes, but is not limited to, a MAC address of the VM, an IP address of the VM, an IP address of the VTEP connected to the VM and the VNID associated with the VM. As shown in FIG. 1, the SDN VXLAN network 110 also comprises a SDN controller 115 enabling such a query. Likewise, the SDN controller 115 may be located within one or more computing devices in the underlying physical network. After receiving the endpoint information from the SDN controller 115, the VTEP 111 or 112 may cache the information locally. In this way, the VTEP 111 or 112 does not have to query the controller 115 the next time.

In addition to querying the SDN controller 115 about the endpoint information associated with the destination VM, the VTEP 111 or 112 also registers the endpoint information associated with the source VM to the controller 115. For example, in the case that the VMs 113 and 114 belong to the same VXLAN segment that corresponds to a VNID, after the VTEP 111 receives from the VM 113 an address resolution protocol (ARP) request for resolving the IP address of the VM 114 to the corresponding MAC address, the VTEP 111 searches its local cache for the MAC address. If the MAC address is not found, the VTEP 111 queries the controller 115 about the endpoint information associated with the VM 114. If the controller 115 is unaware of the endpoint information, the controller 115 may instruct all the VTEPs containing the VNID to perform the resolution. After the VTEP 112 receives the instruction, the VTEP 112 may query the VMs connected thereto. If an ARP response is received from the VM 114, the VTEP 112 will register to the controller 115 the associated endpoint information contained in the ARP response.

As described above, the framework of the non-SDN VXLAN network 120 is specified by the IETF in RFC 7348, while the framework of the SDN VXLAN network 110 is specified by a specific vendor. Due to the different standardization of the frameworks of the two types of VXLAN networks, VMs in a non-SDN VXLAN network may not be able to communicate with those in a SDN VXLAN network, and VMs in a SDN VXLAN network from one vendor may not be able to communicate with those in a SDN VXLAN network from another vendor.

According to example embodiments of the present invention, as shown in FIG. 1, a communication device termed as a mediator 130 is arranged between the SDN VXLAN network 110 and the non-SDN VXLAN network 120. The mediator 130 may likewise be located within one or more computing devices in the underlying physical network. In the case that the SDN VXLAN network 110 and the non-SDN VXLAN network 120 use the same VNID, with the mediator 130, the VM 113 or 114 in the SDN VXLAN network 110 may obtain the MAC address of the VM 123 or 124 in the non-SDN VXLAN network 120, and the VTEP 111 or 112 in the SDN VXLAN network 110 may obtain the mapping of the MAC address of the VM 123 or 124 to the IP address of the VTEP 121 or 122 in the non-SDN VXLAN network 120. As a result, the VM 113 or 114 may directly communicate with the VM 123 or 124.

FIG. 2 shows an example structure of the mediator 130 according to one example embodiment of the present invention. As shown, the mediator 130 comprises two VTEPs including a first VTEP 210 and a second VTEP 220. The first VTEP 210 is coupled to a first overlay network, and the second VTEP 220 is coupled to a second overlay network using a same virtual network identifier as the first overlay network. As used herein, the term “virtual network identifier” refers to any suitable identifier that can identify an overlay network. Examples of such an identifier include, but are not limited to, a VNID.

According to example embodiments of the present invention, the first and second overlay networks may be any suitable types of overlay networks which conform to a standard, for example an IETF standard, or may be provided by a specific vendor. Accordingly, the first and second VTEPs 210 and 220 function as the VTEPs within the first and second overlay networks, respectively. It would be appreciated the number of the VTEPs in the mediator 130 is only for the purpose of illustration without suggesting the limitations. The mediator 130 may comprise any suitable number of VTEPs coupled to the corresponding number of overlay networks to enable the interconnection of these overlay networks.

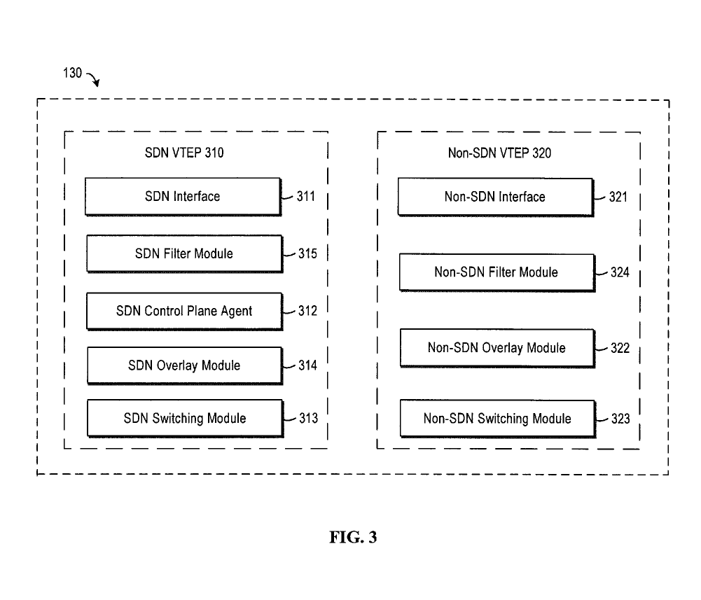

According to example embodiments of the present invention, the first VTEP 210 in the mediator 130 receives, from the first overlay network, an address resolution request for a destination VM in the second overlay network, wherein the address resolution request carries an IP address of the destination VM. The address resolution request includes at least one of an ARP request for the destination VM and an endpoint information resolution request for the destination VM. In the context of the present invention, the term “the ARP request/response” refers to an address resolution request/response based on an ARP packet. The term “the endpoint information resolution request/response” refers to an address resolution request/response delivered over an SDN control plane. The implementations of the address resolution request depends on the implementations of the first overlay network, which will be described in detail below with reference to FIG. 3.

With the mediator 130, the address resolution request originated from the first overlay network may be forwarded to the second overlay network. The second VTEP 220 in the mediator 130 may receive from the second overlay network an address resolution response as a response to the address resolution request from the first overlay network. Then, the second VTEP 220 obtains the endpoint information associated with the destination VM from the address resolution response. The obtained address may be sent to the first overlay network via the mediator 130. In this way, the source VM in the first overlay network may be aware of the MAC address of the destination VM in the second overlay network, and the source VTEP in the first overlay network may be aware of the mapping of the MAC address of the destination VM to the IP address of the destination VTEP in the second overlay. As a result, the VMs in the different overlay networks may directly communicate. Systems implemented according to embodiments of the present invention may thus avoid or alleviate issues of traffic bottlenecks and/or single point failures which might otherwise exist.

FIG. 3 shows an example structure of the mediator 130 according to another example embodiment of the present invention. In this example, the mediator 130 comprises a SDN VTEP 310 coupled to a SDN VXLAN network and a non-SDN VTEP 320 coupled to a non-SDN VXLAN network. It would be understood that the mediator 130 may be applied to the environment 100 in FIG. 1. Accordingly, the SDN VTEP 310 is coupled to the SDN VXLAN network 110, and the non-SDN VTEP 320 is coupled to the non-SDN VXLAN network 120.

It would be understood that the types of the VTEPs in the mediator 130 is only for the purpose of illustration without suggesting the limitations. According to example embodiments of the present invention, the mediator 130 may comprise any suitable types of VTEPs coupled to the corresponding types of overlay networks. For example, the mediator 130 may comprise two SDN VTEPs coupled to two SDN VXLAN networks.

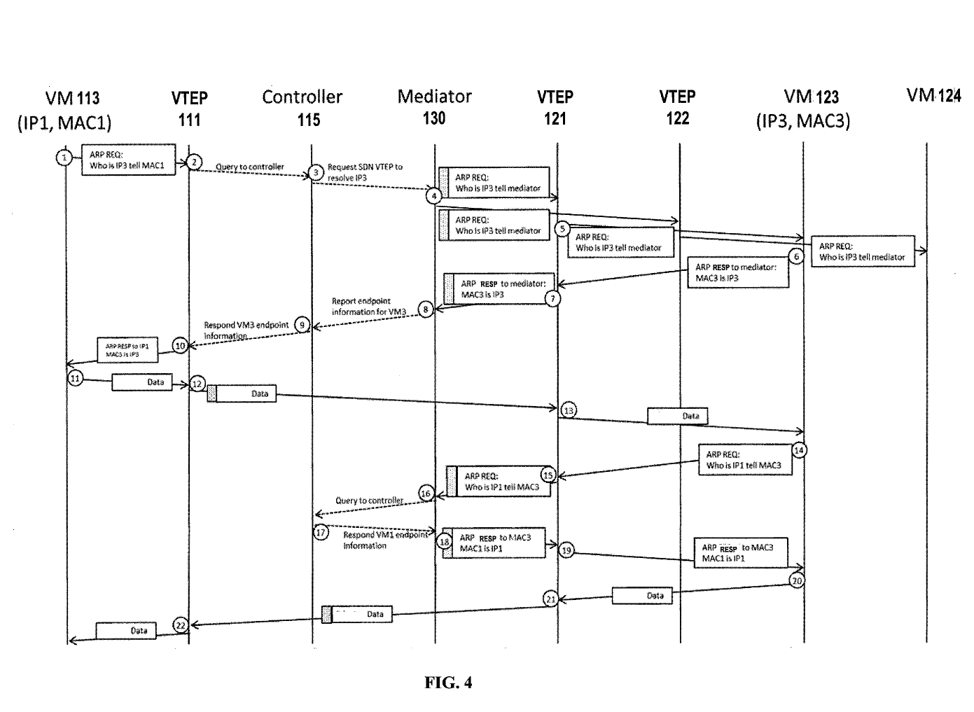

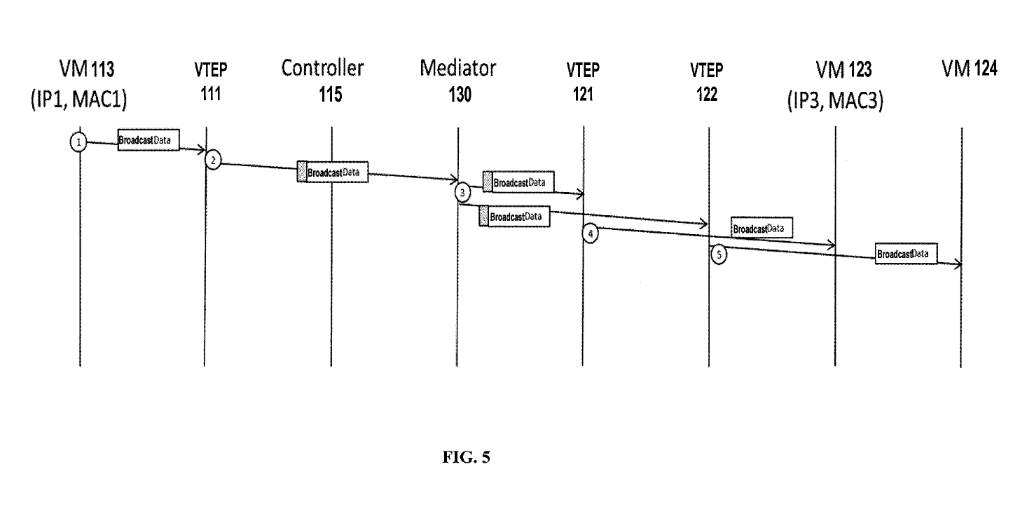

As shown in FIG. 3, the SDN VTEP 310 comprises a SDN interface 311 coupled to the SDN VXLAN network 110, a SDN control plane agent 312 and a SDN switch module 313. The non-SDN VTEP 320 comprises a non-SDN interface 321 coupled to the non-SDN VXLAN network 120, a non-SDN overlay module 322 and a non-SDN switch module 323. The functions of the components of the SDN VTEP 310 and the non-SDN VTEP 320 will be described below with reference to FIG. 4 which shows an example scenario where the mediator 130 enables the communication between the VM 113 in the SDN VXLAN network 110 and the VM 123 in the non-SDN VXLAN network 120.

In the scenario as shown in FIG. 4, the VM 113 in the SDN VXLAN network 110 wants to communicate with the VM 123 using an IP address “IP3” in the non-SDN VXLAN network 120. The source VM 113 sends to the source VTEP 111 connected thereto in the SDN VXLAN network 110 an ARP request for resolving the IP address “IP3” to a corresponding MAC address. After receiving the ARP request, the VTEP 111 searches the forwarding table in the local cache for a forwarding entry corresponding to the VNID with which the VM 113 is associated. If the MAC address of the destination VM 123 is found, the VTEP 111 sends back to the VM 113 an ARP response carrying the MAC address. If the MAC address is not found, the VTEP 111 sends to the SDN controller 115 an endpoint information resolution request for the endpoint information associated with the VM 123. In the meanwhile, the VTEP 111 registers the endpoint information associated with the VM 113 to the controller 115.

After the SDN controller 115 receives the request from the VTEP 111, the controller determines the endpoint information associated with the destination VM 123. If the SDN controller 115 is unaware of the endpoint information, the controller 115 issues an endpoint information resolution request to each of the SDN VTEPs containing the VNID to query about the endpoint information associated with the VM 123 using the IP address “IP3.”

In this case, the mediator 130 may receive the endpoint information resolution request sent by the controller 115 in the SDN VXLAN network 110 and then forward the endpoint information resolution request to the non-SDN VXLAN network 120. Specifically, the SDN interface 311 of the SDN VTEP 310 in the mediator 130 receives the endpoint information resolution request from the controller 115. Then, the SDN control plane agent 312 generates an ARP request based on the received endpoint information resolution request, wherein the ARP request contains the MAC address of the mediator 130 as the source MAC address. Through the SDN switch module 313 of the SDN VTEP 310 and the non-SDN switch module 323 of the non-SDN VTEP 320, the ARP request is entered into the non-SDN VTEP 320.

After the ARP request is received, the non-SDN overlay module 322 of the non-SDN VTEP 320 encapsulates the ARP request by using the IP address of the non-SDN VTEP 320 as the source IP address of the outer header. The non-SDN interface 321 coupled to the non-SDN VXLAN network 120 sends the encapsulated ARP request to the non-SDN VXLAN network 120. In this way, the address resolution request from the controller 115 in the SDN VXLAN network 110 may be forwarded to the non-SDN VXLAN network 120.

The encapsulated ARP request may be sent to the non-SDN VXLAN network 120 in any suitable ways. For example, the encapsulated ARP request may be broadcast to all VTEPs 121 and 122 in the non-SDN VXLAN network 120. Specifically, the ARP request is encapsulated into an overlay packet by inserting the outer header containing an IP multicast group address of the non-SDN VXLAN network 120 as the destination IP address. Accordingly, the encapsulated ARP request is delivered to the VTEPs 121 and 122 in the non-SDN VXLAN network 120. As an alternative example, the encapsulated ARP request may be unicast to the VTEPs 121 and 122 in the non-SDN VXLAN network 120 by inserting the IP addresses of the VTEPs 121 and 122 into the outer header as the destination IP address, respectively.

In the scenario as shown in FIG. 4, after the VTEP 121 or 122 in the non-SDN VXLAN network 120 receives the encapsulated ARP request, the VTEP 121 or 122 decapsulates it into the ARP request and then delivers the ARP request to all the VMs connected thereto and associated with the VNID. In the meanwhile, the VTEP 121 or 122 also learns the mapping of the MAC address of the mediator 130 to the IP address of the non-SDN VTEP 320 of the mediator 130 since the MAC address of the mediator 130 as the source MAC address has been contained in the inner header and the IP address of the non-SDN VTEP 320 as the source IP address has been contained in the outer header.

After the destination VM 123 receives the ARP request from the destination VTEP 121, the VM 123 replies with an ARP response which contains the MAC address “MAG3” of the VM 123 as the source MAC address and contains the MAC address of the mediator 130 as the destination MAC address. Upon the reception of the ARP response, the VTEP 121 obtains the mapping from the MAC address of the mediator 130 to the IP address of non-SDN VTEP 320 by looking up the forwarding table. Then, the VTEP 121 encapsulates the ARP response by inserting the outer header containing the IP address of the VTEP 121 as the source IP address and the IP address of the non-SDN VTEP 320 as the destination IP address. The VTEP 121 sends the encapsulated ARP response to the mediator 130.

According to example embodiments of the present invention, the mediator 130 may also forward the endpoint information associated with the destination VM 123 from the non-SDN VXLAN network 120 to the SDN VXLAN network 110. Specifically, the non-SDN interface 321 of the non-SDN VTEP 320 receives the encapsulated ARP response from the non-SDN VXLAN network 120. The non-SDN overlay module 322 decapsulates the encapsulated ARP response into the ARP response and obtains the endpoint information associated with the destination VM 123. The non-SDN switch module 323 of the non-SDN VTEP 320 transmits the ARP response to the SDN switch module 313 of the SDN VTEP 310. After the ARP response is received, the SDN control plane agent 312 retrieves the endpoint information obtained by the non-SDN overlay module 322 of the non-SDN VTEP 320. Then, the SDN control plane agent 312 generates an endpoint information resolution response carrying the obtained endpoint information and sends the endpoint information resolution response to the SDN controller 115 in the SDN VXLAN network 110 via the SDN interface 311.

For ease of operations, in one example embodiment, the obtained endpoint information may be stored at the mediator 130 by the non-SDN overlay module 322 of the non-SDN VTEP 320. Accordingly, the SDN control plane agent 312 of the SDN VTEP 310 may search the mediator 130 for the endpoint information. The storing of the endpoint information may be implemented in any suitable ways. For example, the endpoint information may be stored in metadata associated with the ARP response derived after the decapsulating.

With the forwarding of the endpoint information associated with the destination VM 123 by the mediator 130 from the non-SDN VXLAN network 120 to the SDN VXLAN network 110, the source VM 113 of the SDN VXLAN network 110 may directly transmit data to the destination VM 120 of the non-SDN VXLAN network 120. For example, as shown in FIG. 4, after the SDN controller 115 receives the endpoint information associated with the destination VM 123, the controller 115 sends an endpoint information resolution response to the endpoint information resolution request from the VTEP 111. The response carries the endpoint information associated with the destination VM 123. When the VTEP 111 receives the endpoint information, it uses the information to create an entry for the VM 123 in the forwarding table, and at the same time, sends to the VM 113 an ARP response carrying the resolution result of the IP address “IP3” to the MAC address “MAC3.” After learning the MAC address of the VM 123, the VM 113 may directly send data to the VM 123.

In the scenario as shown in FIG. 4, the communication between the VM 113 of the SDN VXLAN network 110 and the VM 123 of the non-SDN VXLAN network 120 is bidirectional. For example, after the VM 123 in the non-SDN VXLAN network 120 receives the data transmitted from the VM 113 in the SDN VXLAN network 110, the VM 123 may send response data to the VM 113. In this case, since the VM 123 is unaware of a MAC address of the VM 113, the VM 123 also sends an ARP request for resolving the IP address “IP1” of the VM 113 to a corresponding MAC address, wherein the ARP request contains the MAC address of the VM 113 as the source MAC address.

After the VTEP 121 receives the ARP request from the VM 123, the VTEP 121 looks up the local forwarding table for the mapping relation. If the mapping is not found, the VTEP 121 encapsulates the ARP request by inserting the outer header containing the IP address of the VTEP 121 as the source IP address and broadcasts the encapsulated ARP request in the non-SDN VXLAN network 120. Accordingly, the mediator 130 may receive the encapsulated ARP request.

According to example embodiments of the present invention, the mediator 130 may likewise forward the encapsulated ARP request from the non-SDN VXLAN network 120 to the SDN VXLAN network 110. Specifically, after the encapsulated ARP request is received by the non-SDN interface 321 of the non-SDN VTEP 320 from the non-SDN VXLAN network 120, the non-SDN overlay module 322 decapsulates the encapsulated ARP request into an ARP request. Then, the non-SDN switch module 313 sends the ARP request to the SDN switch module 313 of the SDN VTEP 310.

After the ARP request is received via the SDN switch module 323, the SDN control plane agent 312 of the SDN VTEP 310 generates an endpoint information resolution request based on the received ARP request. Then, the endpoint information resolution request is sent to the SDN controller 115 of the SDN VXLAN network 110 via the SDN interface 311. In this way, the address resolution request originated from the non-SDN VXLAN network 120 may be forwarded to the SDN VXLAN network 110.

In one example embodiment, the mediator 130 may register to the SDN controller 115 the mapping of the MAC address of the VM 123 to the IP address of the VTEP 121. For example, after the encapsulated ARP request is entered into the non-SDN VTEP 320 from the non-SDN VXLAN network 120 via the non-SDN interface 321, the non-SDN overlay module 322 obtain the endpoint information associated with the VM 123. Then, after the ARP request generated after the decapsulating is entered into the SDN VTEP 310 via the SDN switch module 313, the SDN control plane agent 312 retrieves the obtained endpoint information and registers the retrieved endpoint information to the SDN controller 115 via the SDN interface 311.

Likewise, the endpoint information obtained by non-SDN overlay module 322 of the non-SDN VTEP 320 may be stored at the mediator 130. Accordingly, the SDN control plane agent 312 of the SDN VTEP 310 may search the mediator 130 for the endpoint information. Likewise, the endpoint information may be stored in metadata associated with the ARP request generated after the decapsulating.

As described above, the SDN controller 115 is able to learn the endpoint information of the VM 113 from the VTEP 111 when the VM 113 sends the ARP request for the VM 123. As a result, in response to receiving the endpoint information resolution request from the mediator 130, the SDN controller 115 responds to the mediator 130 with the endpoint information associated with the VM 113. Accordingly, the mediator 130 may forward the endpoint information to the non-SDN VXLAN network 120.

Specifically, the SDN interface 311 of the SDN VTEP 310 receives the endpoint information resolution response from the SDN controller 115. The SDN control plane agent 312 obtains the endpoint information associated with the VM 113 from the received endpoint information resolution response and generates an ARP response carrying the MAC address in the obtained endpoint information as the source MAC address. Then, the ARP response is transmitted from the SDN VTEP 310 to the non-SDN VTEP 320 via the SDN switch module 323 and the non-SDN switch module 313.

After the ARP response is received, the non-SDN overlay module 322 encapsulates the ARP response by inserting an outer header containing the IP address in the obtained endpoint information as the source IP address. Then, the non-SDN interface 313 sends the encapsulated ARP response to the non-SDN VXLAN network 120. In this way, the endpoint information associated with the VM 113 may be forwarded from the SDN VXLAN network 110 to the non-SDN VXLAN network 120.

In the scenario as shown in FIG. 4, the VTEP 121 in the non-SDN VXLAN network 120 may receive the encapsulated ARP response sent by the mediator 130. Then, the VTEP 121 decapsulates the encapsulated ARP response into the ARP response and delivers the ARP response to the VM 123. After the VM 123 learns the MAC address “MAC1” of the VM 113, the VM 123 may directly send data to the VM 113 using the MAC address “MAC1” as the destination MAC address.

According to example embodiments of the present invention, with the mediator 130, the endpoint information associated with the VMs in the different overlay networks may be forwarded between each other, and accordingly the VMs may directly communicate with each other. Compared with the conventional approach, the approach with the mediator 130 may avoid the performance bottle and the single point of failure and therefore be more effective and efficient. Systems implemented according to embodiments of the present invention may thus avoid or alleviate issues of traffic bottlenecks and/or single point failures which might otherwise exist.

In one example embodiment, when the mediator 130 forwards the endpoint information associated with the VM from one overlay network to another overlay network, the mediator 130 may store the endpoint information in a local forwarding table. Accordingly, when the mediator 130 receives an address resolution request for the endpoint information next time, the mediator 130 may search the table for the endpoint information and respond with the searched endpoint information to the requestor so as to enable a more efficient address resolution.

In addition to forwarding the endpoint information as described above, in one example embodiment, the mediator 130 may forward the broadcast communication from one overlay network to another overlay network. The function of forwarding the broadcast communication will be described below with reference to FIG. 5 which shows a process of forwarding a broadcast packet by the mediator 130 from the SDN VXLAN network 110 to the non-SDN VXLAN network 120.

As shown in FIG. 5, the VM 113 in the SDN VXLAN network 110 sends a MAC broadcast packet which contains the MAC address of the VM 113 as the source MAC address. After the VTEP 111 connected to the VM 113 receives the MAC packet, the VTEP 111 obtains the VNID associated with the VM 113 and encapsulates the MAC broadcast packet into a plurality of IP packets by respectively using each of the IP addresses of all the VTEPs in the SDN VXLAN network 110 as the destination IP address of the outer header. Furthermore, the VTEP 111 inserts its own IP address in the outer header as the source IP address. In this case, as a member of the SDN VXLAN network 110, the mediator 130 may receive one of the IP packets. For example, the SDN VTEP 310 of the mediator 130 may receive the IP packet via the SDN interface 311. It should be understood that as an alternative example, instead of the SDN interface 311, the IP packet may be received via another interface in the SDN VTEP 310.

As shown in FIG. 3, the SDN VTEP 310 in the mediator 130 also comprises a SDN overlay module 314. After the IP packet is received from the SDN VXLAN network 110, the SDN overlay module 314 decapsulates the IP packet into the MAC broadcast packet. Then, the SDN switch module 313 transmits the MAC broadcast packet to the non-SDN switch module 323 of the non-SDN VTEP 320.

Upon the reception of the MAC packet, the non-SDN overlay module 322 encapsulates the MAC broadcast packet into a further IP packet by inserting the outer header containing an IP multicast group address of the second overlay network as the destination IP address. Accordingly, the encapsulated IP packet may be sent to all of the VTEPs 121 and 122 in the non-SDN VXLAN network 120. In this way, the packet broadcast in the SDN VXLAN network 110 may be forwarded to the non-SDN VXLAN network 120.

Furthermore, the SDN overlay module 314 may obtain the IP address of the VTEP 111 as the source IP address in the outer header of the IP packet received from the SDN VXLAN network 110. Accordingly, the non-SDN overlay module 322 may use the IP address of the VTEP 111 as the source IP address of the outer header of the further IP packet. As a result, the VTEPs 121 and 122 in the non-SDN VXLAN network 120 may learn the mapping of the MAC address of the VM 113 to the IP address of the VTEP 111.

Similar to the endpoint information associated with the VM obtained by the mediator 130, the obtained IP address of the VTEP 111 may also be stored at the mediator 130 by the SDN overlay module 314 of the SDN VTEP 310. Accordingly, non-SDN overlay module 322 of the non-SDN VTEP 320 may search the mediator 130 for the IP address of the VTEP 111. Likewise, the endpoint information may be stored in metadata associated with the MAC packet derived after decapsulating the IP packet.

The forwarding process from the non-SDN VXLAN network 120 to the SDN VXLAN network 110 is similar to the forwarding process from the SDN VXLAN network 110 to the non-SDN VXLAN network 120 as described above. The difference is that forms of the IP packets received and transmitted by the mediator 130 are different. For example, the non-SDN VTEP 320 of the mediator 130 may receive an IP multicast packet via the non-SDN interface 321 from the non-SDN VXLAN network 110. The IP multicast packet is generated by a VTEP in the non-SDN VXLAN network 110 by encapsulating the MAC broadcast packet using an IP multicast group address. Furthermore, the SDN overlay module 322 of the SDN VTEP 320 encapsulates the MAC broadcast packet into a plurality of IP packets by respectively using each of the IP addresses of all the VTEPs in the SDN VXLAN network 110 as the destination IP address of the outer header.

In the scenario as shown in FIG. 5, after the VM 113 broadcasts the packet, the broadcast packet is flooded through the underlying physical network. This may cause the reception of the broadcast packet at both the SDN VTEP 310 and the non-SDN VTEP 320 in the mediator 130. If both the SDN VTEP 310 and the non-SDN VTEP 320 perform the forwarding, a problem of a forwarding loop or a broadcast storm may occur.

In order to avoid such a problem, in one example embodiment, the mediator 130 may comprise a filter module in an internal VTEP, such as the SDN VTEP 310 and the non-SDN VTEP 320. The filter module may enable a packet received from an external overlay network to be processed only by the corresponding internal VTEP. For example, as shown in FIG. 3, in the mediator 130, the SDN VTEP 310 may comprise a SDN filter module 315, and the non-SDN VTEP 320 may comprise a non-SDN filter module 324. With the SDN filter module 315 and the non-SDN filter module 324, only the SDN VTEP 310 processes the packet originated from the SDN VXLAN network 110, and only the non-SDN VTEP 320 processes the packet originated from the non-SDN VXLAN network 120.

According to example embodiments of the present invention, the filter module may use a filter rule to determine whether a received packet will be delivered to the subsequent components in the internal VTEP. Specifically, if the packet meets the filtering rule, the packet will be delivered; otherwise, the packet will be dropped.

Any suitable filtering rules may be used by the filter module. In one example embodiment, the filtering rule may be based on an access control list (ACL) which contains allowed IP addresses or IP subnets. If the received packet uses an IP address or IP subnet contained in the ACL, the packet will be allowed to be passed. It should be understood that the usage of the ACL as the filtering rule is only for the purpose of illustration without suggesting any limitation. The scope of the present invention will not be limited in this regard.

The modules included in the mediator 130 may be implemented in various manners, including software, hardware, firmware, or any combination thereof. In one example embodiment, one or more modules may be implemented using software and/or firmware, for example, machine-executable instructions stored on the storage medium. In addition to or instead of machine-executable instructions, parts or all of the modules in the mediator 130 may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

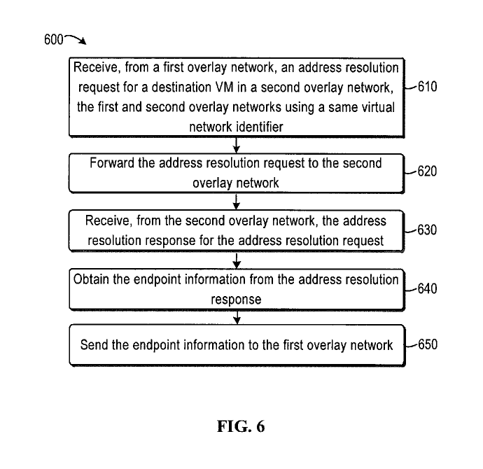

FIG. 6 shows a flowchart of a communication method 600 in accordance with one example embodiment of the present invention. It would be appreciated that the method 600 may be implemented by the mediator 130 as shown in FIGS. 1 and 2.

As shown in FIG. 6, at 610, where an address resolution request for a destination VM in a second overlay network is received from a first overlay network. The first and second overlay networks use a same virtual network identifier, and the address resolution request containing an Internet Protocol (IP) address of the destination VM.

At 610 where the address resolution request is forwarded to the second overlay network. At 620, the address resolution response for the address resolution request is received from the second overlay network. The endpoint information associated with the destination VM is obtained from the address resolution response at 630 and then sent to the first overlay network at 640.

In one example embodiment, the first overlay network may be a SDN VXLAN network, and the second overlay network may be a non-SDN VXLAN network. In this case, the step of receiving the address resolution request from the first overlay network may comprise: receiving the endpoint information resolution request from a SDN controller of the SDN VXLAN network. The step of forwarding the address resolution request to the second overlay network may comprise: generating an ARP request based on the received endpoint information resolution request, the ARP request using a MAC address of the communication device as a source MAC address, encapsulating the ARP request by inserting an outer header containing an IP address of the non-SDN VTEP as the source IP address, and sending the encapsulated ARP request to the non-SDN VXLAN network.

Alternatively or additionally, in this case, the step of receiving the address resolution response from the second overlay network may comprise: receiving an encapsulated ARP response from the non-SDN VXLAN network. The step of obtaining the endpoint information from the address resolution response may comprise: obtaining the endpoint information from the encapsulated ARP response. The step of sending the endpoint information to the first overlay network may comprise: generating an endpoint information resolution response carrying the obtained endpoint information, and sending the endpoint information resolution response to the SDN controller.

In one example embodiment, the first overlay network may be a non-SDN VXLAN network, and the second overlay network is a SDN VXLAN network. In this case, the step of receiving the address resolution request from the first overlay network may comprise: receiving an encapsulated ARP request for the destination VM from the non-SDN VXLAN network. The step of forwarding the address resolution request to the second overlay network may comprise: decapsulating the encapsulated ARP request into an ARP request, generating an endpoint information resolution request based on the ARP request, and sending the endpoint information resolution request to a SDN controller of the SDN VXLAN network. In this case, in one example embodiment, the method 600 may further comprise: obtaining further endpoint information associated with a source VM; and sending the further endpoint information to the SDN controller.

Alternatively or additionally, in this case, the step of receiving the address resolution response from the second overlay network may comprise: receiving the endpoint information resolution response from the SDN controller. The step of obtaining the endpoint information from the address resolution response may comprise: obtaining the endpoint information from the received endpoint information resolution response. The step of sending the endpoint information to the first overlay network may comprise: generating an ARP response using a MAC address in the obtained endpoint information as a source MAC address, encapsulating the ARP response by inserting an outer header containing an IP address in the obtained endpoint information as a source IP address, and sending the encapsulated ARP response to the non-SDN VXLAN network.

In one example embodiment, the method 600 may further comprise: receiving an IP packet from the first overlay network, the IP packet being generated by encapsulating a MAC broadcast packet; and forwarding the IP packet to the second overlay network.

In one example embodiment, the step of forwarding the IP packet to the second overlay network may comprise: decapsulating the IP packet into the MAC broadcast packet; encapsulating the MAC broadcast packet into a further IP packet by inserting an outer header containing an IP address associated with the second overlay network as a destination IP address; and transmitting the further IP packet to the second overlay network.

In one example embodiment, the method 600 may further comprise: obtaining an original source IP address of the IP multicast packet received from the first overlay network. In this example, the step of encapsulating the MAC broadcast packet into a further IP packet comprising: using the original source IP address as a source IP address of the further IP packet.

It should be appreciated that the functions of the modules included in the mediator 130 correspond to the steps of the method 600. Therefore, all operations and features described above with reference to FIGS. 2 to 5 are likewise applicable to the steps of the method 600 and have similar effects. For the purpose of simplification, the details will be omitted.

Generally, various embodiments of the present invention may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present invention are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

By way of example, embodiments of the present invention can be described in the general context of machine-executable instructions, such as those included in program modules, being executed in a device on a target real or virtual processor. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present invention may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this invention, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present invention, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present invention has been described in language specific to structural features and/or methodological acts, it is to be understood that the present invention defined in the appended claims is not necessarily limited to the specific features or acts described above. Rather, the specific features and acts described above are disclosed as example forms of implementing the claims.

1-24. (canceled)

25. A communication method, comprising:
receiving, from a first overlay network, an address resolution request for a destination virtual machine in a second overlay network, the first and second overlay networks using a same virtual network identifier, and the address resolution request containing an internet protocol address of the destination virtual machine;
forwarding the address resolution request to the second overlay network;
receiving, from the second overlay network, the address resolution response for the address resolution request;
obtaining the endpoint information associated with the destination virtual machine from the address resolution response; and
sending the endpoint information to the first overlay network.

26. The communication method according to claim 25, wherein the first overlay network is a software defined network (SDN) virtual extensible local area network (VXLAN) network, and the second overlay network is a non-SDN VXLAN network.

27. The communication method according to claim 26, wherein receiving the address resolution request from the first overlay network comprises: receiving the endpoint information resolution request from a SDN controller of the SDN VXLAN network, and
wherein forwarding the address resolution request to the second overlay network comprises:
generating an address resolution protocol (ARP) request based on the received endpoint information resolution request, the ARP request using a media access control (MAC) address of the communication device as a source MAC address,
encapsulating the ARP request by inserting an outer header containing an internet protocol address of the non-SDN virtual tunnel end point as the source internet protocol address, and
sending the encapsulated ARP request to the non-SDN VXLAN network.

28. The communication method according to claim 27, wherein receiving the address resolution response from the second overlay network comprises: receiving an encapsulated ARP response from the non-SDN VXLAN network,
wherein obtaining the endpoint information from the address resolution response comprises: obtaining the endpoint information from the encapsulated ARP response, and
wherein sending the endpoint information to the first overlay network comprises:
generating an endpoint information resolution response carrying the obtained endpoint information, and
sending the endpoint information resolution response to the SDN controller.

29. The communication method according to claim 25, wherein the first overlay network is a non-software defined network (SDN) virtual extensible local area network (VXLAN) network, and the second overlay network is a SDN VXLAN network.

30. The communication method according to claim 29, wherein receiving the address resolution request from the first overlay network comprises: receiving an encapsulated address resolution protocol (ARP) request for the destination virtual machine from the non-SDN VXLAN network, and
wherein forwarding the address resolution request to the second overlay network comprises:
decapsulating the encapsulated ARP request into an ARP request,
generating an endpoint information resolution request based on the ARP request, and
sending the endpoint information resolution request to a SDN controller of the SDN VXLAN network.

31. The communication method according to claim 30, wherein receiving the address resolution response from the second overlay network comprises: receiving the endpoint information resolution response from the SDN controller,
wherein obtaining the endpoint information associated with the destination virtual machine from the address resolution response comprises: obtaining the endpoint information from the received endpoint information resolution response, and
wherein sending the endpoint information to the first overlay network comprises:
generating an ARP response using a media access control (MAC) address in the obtained endpoint information as a source MAC address,
encapsulating the ARP response by inserting an outer header containing an internet protocol address in the obtained endpoint information as a source internet protocol address, and
sending the encapsulated ARP response to the non-SDN VXLAN network.

32. The communication method according to claim 25, further comprising:
receiving an internet protocol packet from the first overlay network, the internet protocol packet being generated by encapsulating a media access control (MAC) broadcast packet; and
forwarding the internet protocol packet to the second overlay network.

33. The communication method according to claim 32, wherein forwarding the internet protocol packet to the second overlay network comprises:
decapsulating the internet protocol packet into the MAC broadcast packet;
encapsulating the MAC broadcast packet into a further internet protocol packet by inserting an outer header containing an internet protocol address associated with the second overlay network as a destination internet protocol address; and
transmitting the further internet protocol packet to the second overlay network.

34. The communication method according to claim 33, further comprising:
obtaining an original source internet protocol address of the internet protocol packet received from the first overlay network,
wherein encapsulating the MAC broadcast packet into a further internet protocol packet comprising: using the original source internet protocol address as a source internet protocol address of the further internet protocol packet.

35. A communications apparatus, comprising at least one processor and at least one memory including computer program code, the at least one memory and the computer program code configured to, with the processor, cause the apparatus to at least:
receive, from a first overlay network, an address resolution request for a destination virtual machine in a second overlay network, wherein the first and second overlay networks use a same virtual network identifier, and wherein the address resolution request contains an internet protocol address of the destination virtual machine;
forward the address resolution request to the second overlay network;
receive, from the second overlay network, an address resolution response for the address resolution request;
obtain an endpoint information associated with the destination virtual machine from the address resolution response; and
send the endpoint information to the first overlay network.

36. The apparatus of claim 35, wherein the first overlay network is a software defined network (SDN) virtual extensible local area network (VXLAN) network, and the second overlay network is a non-SDN VXLAN network.

37. The apparatus of claim 36, wherein to receive the address resolution request from the first overlay network, the at least one memory and the computer program code are further configured to, with the processor, cause the apparatus to at least: receive an endpoint information resolution request from a SDN controller of the SDN VXLAN network, and
wherein to forward the address resolution request to the second overlay network, the at least one memory and the computer program code are further configured to, with the processor, cause the apparatus to at least:
generate an address resolution protocol (ARP) request based on the received endpoint information resolution request, wherein the ARP request uses a media access control (MAC) address of the communication device as a source MAC address,
encapsulate the ARP request by inserting an outer header containing an internet protocol address of the non-SDN virtual tunnel end point as a source internet protocol address, and
send the encapsulated ARP request to the non-SDN VXLAN network.

38. The apparatus of claim 37, wherein to receive the address resolution response from the second overlay network, the at least one memory and the computer program code are further configured to, with the processor, cause the apparatus to at least: receive an encapsulated ARP response from the non-SDN VXLAN network,
wherein to obtain the endpoint information from the address resolution response, the at least one memory and the computer program code are further configured to, with the processor, cause the apparatus to at least: obtain the endpoint information from the encapsulated ARP response, and
wherein to send the endpoint information to the first overlay network, the at least one memory and the computer program code are further configured to, with the processor, cause the apparatus to at least:
generate an endpoint information resolution response carrying the obtained endpoint information, and
send the endpoint information resolution response to the SDN controller.

39. The apparatus of claim 35, wherein the first overlay network is a non-software defined network (non-SDN) virtual extensible local area network (VXLAN) network, and the second overlay network is a SDN VXLAN network.

40. The apparatus of claim 39, wherein to receive the address resolution request from the first overlay network, the at least one memory and the computer program code are further configured to, with the processor, cause the apparatus to at least: receive an encapsulated address resolution protocol (ARP) request for the destination virtual machine from the non-SDN VXLAN network, and
wherein to forward the address resolution request to the second overlay network, the at least one memory and the computer program code are further configured to, with the processor, cause the apparatus to at least:
decapsulate the encapsulated ARP request into an ARP request,
generate an endpoint information resolution request based on the ARP request, and
send the endpoint information resolution request to a SDN controller of the SDN VXLAN network.

41. The apparatus of claim 40, wherein to receive the address resolution response from the second overlay network, the at least one memory and the computer program code are further configured to, with the processor, cause the apparatus to at least: receive the endpoint information resolution response from the SDN controller,
wherein to obtain the endpoint information associated with the destination virtual machine from the address resolution response, the at least one memory and the computer program code are further configured to, with the processor, cause the apparatus to at least: obtain the endpoint information from the received endpoint information resolution response, and
wherein to send the endpoint information to the first overlay network, the at least one memory and the computer program code are further configured to, with the processor, cause the apparatus to at least:
generate an ARP response using a media access control (MAC) address in the obtained endpoint information as a source MAC address,
encapsulate the ARP response by inserting an outer header containing an internet protocol address in the obtained endpoint information as a source internet protocol address, and
send the encapsulated ARP response to the non-SDN VXLAN network.

42. The apparatus of claim 35, wherein the at least one memory and the computer program code are further configured to, with the processor, cause the apparatus to at least:
receive an internet protocol packet from the first overlay network, the internet protocol packet being generated by encapsulating a media access control (MAC) broadcast packet; and
forward the internet protocol packet to the second overlay network.

43. The apparatus of claim 42, wherein to forward the internet protocol packet to the second overlay network, the at least one memory and the computer program code are further configured to, with the processor, cause the apparatus to at least:
decapsulate the internet protocol packet into the MAC broadcast packet;
encapsulate the MAC broadcast packet into a further internet protocol packet by inserting an outer header containing an internet protocol address associated with the second overlay network as a destination internet protocol address; and
transmit the further internet protocol packet to the second overlay network.

44. The apparatus of claim 43, wherein the at least one memory and the computer program code are further configured to, with the processor, cause the apparatus to at least:
obtain an original source internet protocol address of the internet protocol packet received from the first overlay network,
wherein to encapsulate the MAC broadcast packet into a further internet protocol packet, the at least one memory and the computer program code are further configured to, with the processor, cause the apparatus to at least: use the original source internet protocol address as a source internet protocol address of the further internet protocol packet.
